(19) United States
(12) Patent Application Publication
(10) Pub. No.: US 2013/0323545 A1
(43) Pub. Date: Dec. 5, 2013

(54) Pressure Equalizing Element, Battery having a Pressure Equalizing Element, and Motor Vehicle having a Corresponding Battery

(71) Applicants: Michael Gless, Stuttgart-Zazenhausen (DE); Romuald Fries, Weissach (DE); Alexander Reitzle, Neu-Ulm (DE); Ulrich Zimmermann, Hessigheim (DE)

(72) Inventors: Michael Gless, Stuttgart-Zazenhausen (DE); Romuald Fries, Weissach (DE); Alexander Reitzle, Neu-Ulm (DE); Ulrich Zimmermann, Hessigheim (DE)

(21) Appl. No.: 13/993,455

(22) PCT Filed: Dec. 16, 2011
(86) PCT No.: PCT/EP2011/073007

§ 371 Date: Aug. 20, 2013

(30) Foreign Application Priority Data
Dec. 17, 2010 (DE) 10 2010 063 423.9

(51) Int. Cl. H01M 10/52; H01M 2/12

(52) U.S. Cl. CPC H01M 10/52; H01M 2/1264
USPC 429/57; 96/108; 96/117.5

(57) ABSTRACT

A pressure equalizing element for a housing comprises a head section, a body section, and a duct, through which air can pass and which extends through the head section and the body section. A drying element, which has a desiccant that draws moisture from air flowing through the duct, is arranged in the duct. The disclosure further relates to a battery having said pressure equalizing element and to a motor vehicle having said battery.

The present invention relates to a pressure equalizing element for a housing, said pressure equalizing element having a head section and a body section and a duct, through which duct air can pass and which duct extends through the head section and the body section. In addition, the present invention relates to a battery having this pressure equalizing element and to a motor vehicle having this battery.

### PRIOR ART

Pressure equalizing elements are known. They are used to ventilate and vent sealed housings in order to avoid pressure differences between an internal space and the surrounding area of the housing and to prevent condensate forming in the internal space, said internal space being enclosed by the housing.

DE 10 2006 053 113 A1 discloses a pressure equalizing element for a sealed housing, in particular for a housing that houses an electric circuit, which pressure equalizing element is to ensure that the pressure is reliably equalized whilst maintaining the leak-tightness in areas where high mechanical and fluidic loadings are involved. The pressure equalizing element comprises for this purpose a semi-permeable membrane, which is held by a retaining device, and at least one sealing element in order to provide the sealing arrangement with respect to the housing, wherein the retaining device is embodied by the sealing element.

### DISCLOSURE OF THE INVENTION

A pressure equalizing element is provided in accordance with the invention for a housing, which pressure equalizing element comprises a head section and a body section and a duct, through which duct air can pass and which duct extends through the head section and the body section. A drying element is arranged in the duct, said drying element having a drying agent that draws moisture from the air flowing through the duct.

As a consequence, a pressure equalizing element that has improved air-drying characteristics is advantageously provided. As is the case with known pressure equalizing elements, this pressure equalizing element can be utilized in multiple applications. Furthermore, it is comparatively cost-effective to produce.

In addition, the pressure equalizing element in accordance with the invention having the drying agent provides a sound absorbing function. Noises that occur inside a housing that is provided with the pressure equalizing element thus pass through to the surrounding area to a much lesser extent than in the case of conventional pressure equalizing elements.

In a preferred embodiment of the invention, it is provided that the drying element comprises an indicator for providing information regarding an absorption capacity of the drying agent. Advantageously, information regarding the condition of the drying element can consequently be easily obtained and the level of moisture saturation can be detected.

In a further preferred embodiment of the invention, it is provided that the indicator is an electronic sensor that can be connected to an electronic management system. As a consequence, it is advantageously possible using electronic condition indicators to provide information regarding the condition of the drying agent. In addition, automatic processes can be advantageously introduced according to the condition of the drying agent, for example drying processes.

In a further preferred embodiment of the invention, it is provided that the appearance of the indicator changes depending upon the absorption capacity of the drying agent. As a consequence, it is advantageously possible to detect the absorption capacity of the drying agent with the naked eye without peripheral devices.

Surfaces that change color depending upon the condition of the drying agent are preferably used. These surfaces can be surfaces of the drying agent itself or surfaces of the packaging surrounding the drying agent. The change in color can be identified by the observer from the surrounding area through a simple cut-out, a bore hole or an inspection window.

In a further preferred embodiment of the invention, it is provided that a valve is arranged in the duct in the direction from the head section towards the body section downstream of the drying element. As a consequence, it is advantageously possible to halt the flow of air through the duct by closing the valve. It is possible by means of closing the valve in the case of corresponding external conditions to generate a particular pressure and/or a particular temperature in an internal space which is ventilated and vented by means of the pressure equalizing element and as a consequence as the valve is opened it is possible to generate a flow of warm air that discharges into the surrounding area, which flow of air can be used to purge the drying agent.

In a further preferred embodiment of the invention, it is provided that the valve can be electronically controlled and can be connected to a management system. As a consequence, it is advantageously possible to control the valve, for example by means of a battery management system or a temperature management system. It is thus advantageously possible to open and close the valve in an automated manner and consequently also to purge the drying agent with air in order to dry the drying agent thereby regenerating the drying agent.

In a further preferred embodiment of the invention, it is provided that at least the body section comprises an external screw thread and the form of the head section is such that a form-locking connection can be produced using a tool. As a consequence, the pressure equalizing element in accordance with the invention can be installed in a rapid and cost-effective manner. An additional aim is to render it possible thereby for the pressure equalizing element to be installed in a housing using simple means, for example a hole having an internal thread.

It is preferred that the form of the head section is essentially the form of a screw head. Consequently, it is preferred that the pressure equalizing element can be installed using connection tools.

The pressure equalizing element in accordance with the invention can be used in different systems, for example in the case of headlights, camera lenses or transportation crates. The pressure equalizing element is preferably integrated in an electronics housing, in particular in a battery housing.

In addition, a battery having a housing is consequently provided in accordance with the invention, said housing having a pressure equalizing element that is arranged in the housing of the battery in one of the previously mentioned embodiments. The body section of the pressure equalizing element faces an enclosed internal space that is enclosed by the housing and the head section of the pressure equalizing element faces a surrounding area of the housing. As it is necessary particularly in battery housings to perform a reliable pressure equalization operation by means of the activity of the battery and simultaneously to keep the internal space dry, the advantages of the pressure equalizing element in accordance with the invention come into particular effect.

The embodiment variants having an electronic sensor and an electronically controllable valve are particularly suitable for use in installation situations in which the battery is housed in a manner which makes it more difficult to access, for example in motor vehicles.

The term ‘battery’ in this application also includes battery systems, accumulator batteries, accumulators, accumulator systems, in particular lithium-ion systems or lithium polymer ion systems. In this case, the battery is preferably a lithium-ion battery.

In accordance with the invention, a motor vehicle having a battery is furthermore provided, which battery comprises a pressure equalizing element in one of the previously mentioned embodiments, wherein the battery is connected to a drive system of the motor vehicle. The advantages of the battery in accordance with the invention as a component are also of benefit when installed in the motor vehicle as an assembly.

Advantageous embodiments of the invention are disclosed in the subordinate claims and characterized in the description.

### DRAWINGS

The invention is explained in detail with reference to two drawings and the following description. In the drawings:

FIG. 1 illustrates a pressure equalizing element in accordance with the invention and

FIG. 2 illustrates a sectional view of the pressure equalizing element.

### EMBODIMENTS OF THE INVENTION

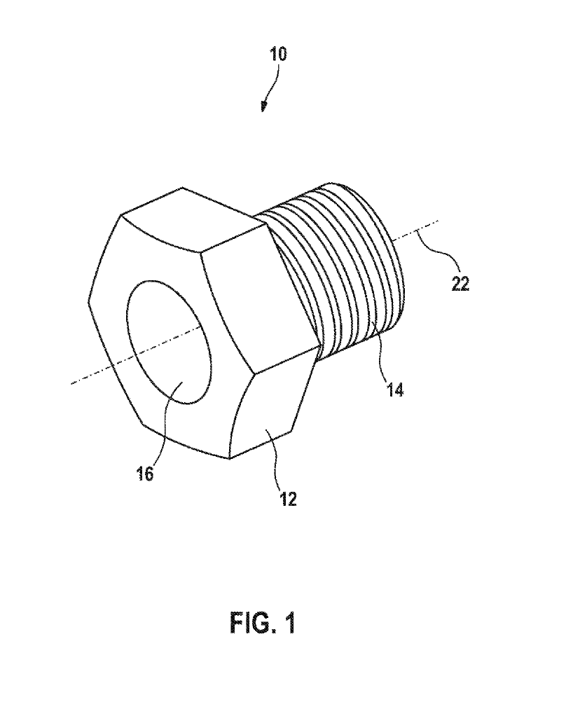

FIG. 1 illustrates an exemplary but not limiting pressure equalizing element 10 in accordance with the invention for ventilating a housing. For this purpose, the pressure equalizing element 10 is to be mounted in a wall of the housing or integrated into the wall of the housing. The pressure equalizing element in the illustrated embodiment is essentially in the form of a screw having a hexagonal head and a threaded shaft. The screw head is embodied by a head section 12 and the shaft by a body section 14. However, the pressure equalizing element 10 can in accordance with the invention be embodied in any other known form of pressure equalizing elements.

It is essential, that when the pressure equalizing element 10 is in the installed state the head section 12 is the part of the pressure equalizing element 10 that faces the surrounding area of the housing and the body section 14 is the part that faces an internal space of the housing. The head section 12 and the body section 14 can also comprise a body that is formed in a similar manner along the longitudinal axis 22. The head section 12 and the body section 14 can consequently also comprise the identical form.

The embodiment of the pressure equalizing element 10 in accordance with the invention as illustrated in FIG. 1 in the form of a screw having a hexagonal head and a threaded shaft is suitable for being installed in a housing in a simple manner by virtue of the fact that the pressure equalizing element 10 can be screwed into a corresponding threaded bore into the housing by means of a corresponding hexagonal wrench. Once installed in a housing, the head section 12 is arranged on an outer face of the housing and the body section 14 is arranged on an inner face of the housing.

In order to be able to equalize the pressure between an internal space, which is enclosed by the housing, and the surrounding area, the pressure equalizing element comprises a duct 16 that provides a through-going passage from the internal space to the surrounding area. In contrast to the embodiment shown in FIG. 1, the duct 16 can also be arranged off-center and/or it can comprise curves. In addition, it is possible that the duct 16 is embodied by several mutually connected or non-connected ducts.

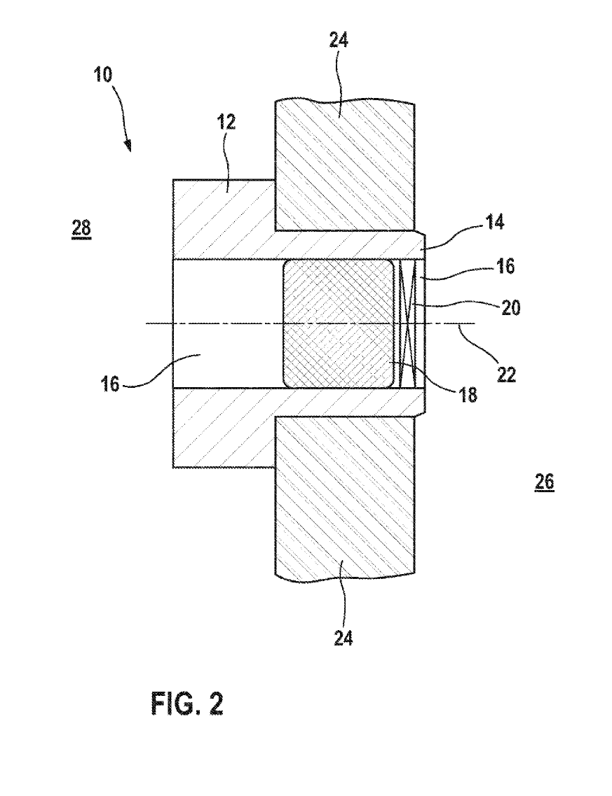

FIG. 2 illustrates a sectional view of the previously described exemplary and non-limiting embodiment of a pressure equalizing element 10 in accordance with the invention in an installed situation. The pressure equalizing element 10 is installed in a housing wall 24 of a housing. The housing wall 24 separates an internal space 26 of the housing from the surrounding area 28 of the housing.

The duct 16 that extends through the head section 12 and the body section 14 is visible in the sectional view. The duct 16 connects the internal space 26 of the housing to the surrounding area 28. The head section 12 faces the surrounding area 28 and the body section 14 faces the internal space 26.

A drying element 18 is arranged inside the duct 16. If air flows pass along the duct 16, then these air flows also pass through the drying element 18. A drying means is arranged in the drying element 18 and said drying means removes the moisture content from the through-flowing air by adhering itself to said moisture content. The moisture content is thus removed from any air that flows from the surrounding area 28 into the internal space 26 and/or said air flow is dried.

The drying element 18 is fixed in the duct 16 using suitable means. Said drying element comprises a packaging which is permeable to air and encloses the drying means. The drying element 18 can also comprise in accordance with the invention several packages containing a drying means. The drying means is characterized by way of hygroscopic characteristics. Said drying means adheres to the moisture content of the air preferably by means of reversible physical processes.

The drying element 18 in a preferred embodiment comprises an indicator that provides information regarding an absorption capacity of the drying means. For example, it is possible for a change in color of the drying means and/or of the packaging at at least one site to function as an indicator, which change in color can be detected from the surrounding area 28. A particular color, a particular shade or a particular identification mark that appears indicates a particular degree of saturation. The drying element 18 itself is used as an optical display and renders it possible for necessary manual interventions to be identified. Thus, the drying means can, for example, be replaced or a procedure for ventilating and/or drying the drying means can be initiated by the user if a correspondingly high level of moisture in the drying means is indicated.

As an alternative to a color change indicator, it is possible to equip the drying element 18 with at least one electronic sensor that detects the moisture in the drying means. The sensor can transmit the ascertained data to an electronic management system, for example a battery management system or a temperature management system, which system indicates by means of a particular signal if the moisture in a drying means exceeds a particular limit or automatically initiates necessary measures. An optical display can be created in an area that is highly visible to the user, for example in a display on an on-board computer of a motor vehicle. An acoustic signal can also be emitted as an indication by the electronic management unit.

In order to dry the drying means, it is possible to purge the drying means automatically with warm air. The heat that is generated inside the housing by the electronic device can be used for this purpose. The pressure equalizing element alternatively comprises for this purpose a valve 20 that is arranged in the direction from the head section 12 to the body section 14 downstream of the drying element 18. This valve 20 can preferably be controlled likewise by the electronic management system, so that it can be kept closed until a particular temperature is achieved in the internal space 26 and associated therewith until a particular pressure is achieved in order to generate a flow of warm air from the internal space 26 through the pressure equalizing element 10 and consequently through the drying means to the surrounding area 28.

In addition, the valve 20 is used for the purpose of avoiding a diffusion of water molecules through the pressure equalizing element 10 in a passive mode of the electronic device when the surrounding area 28 is damp, said electronic device being accommodated in the housing. One example of this is when a battery is used in a parked motor vehicle and the battery is neither being charged nor being discharged.

The pressure equalizing element 10 in accordance with the invention can be used in different systems, for example in the case of headlights, camera lenses, transportation crates or preferably in the case of electronics housings, in particular battery housings.

1. A pressure equalizing element for a housing, comprising:
a head section;
a body section;
a duct (i) defined through the head section and the body section and (ii) being configured for duct air to pass through; and
a drying element (i) positioned in the duct and (ii) including a drying agent that draws moisture from the air flowing through the duct.

2. The pressure equalizing element as claimed in claim 1, wherein the drying element includes an indicator configured to provide information regarding an absorption capacity of the drying agent.

3. The pressure equalizing element as claimed in claim 2, wherein the indicator is an electronic sensor connected to an electronic management system.

4. The pressure equalizing element as claimed in claim 2, wherein an appearance of the indicator changes depending upon the absorption capacity of the drying agent.

5. The pressure equalizing element as claimed in claim 2, wherein a valve is positioned in the duct downstream, in a direction from the head section towards the body section, of the drying element.

6. The pressure equalizing element as claimed in claim 5, wherein the valve is electronically controlled and connected to a management system.

7. The pressure equalizing element as claimed in claim 1, wherein:
the body section includes an external thread, and
the head section is configured such that a form-locking connection is produced using a tool.

8. A battery comprising
a housing having a housing wall, wherein:
a pressure equalizing element is positioned in the housing wall and includes (i) a head section, (ii) a body section, (iii) a duct defined through the head section and the body section, the duct being configured for duct air to pass through, and (iv) a drying element positioned in the duct and including a drying agent that draws moisture from the air flowing through the duct,
the body section of the pressure equalizing element is oriented toward an internal space enclosed by the housing, and
the head section of the pressure equalizing element a is oriented toward an area surrounding the housing.

9. A motor vehicle comprising:
a drive system; and
a battery connected to the drive system, wherein:
the battery includes a housing having a housing wall,
a pressure equalizing element is positioned in the housing wall and the pressure equalizing element includes (i) a head section, (ii) a body section, (iii) a duct defined through the head section and the body section, the duct being configured for duct air to pass through, and (iv) a drying element positioned in the duct and including a drying agent that draws moisture from the air flowing through the duct,
the body section of the pressure equalizing element is oriented toward an internal space enclosed by the housing, and
the head section of the pressure equalizing element is oriented toward an area surrounding the housing.
